(19) United States
(12) Patent Application Publication
(10) Pub. No.: US 2014/0118211 A1
(43) Pub. Date: May 1, 2014

(54) OMNIDIRECTIONAL 3D ANTENNA

(71) Applicants: Henry Cooper, Temecula, CA (US); Sheng Peng, Lynnwood, WA (US)

(72) Inventors: Henry Cooper, Temecula, CA (US); Sheng Peng, Lynnwood, WA (US)

(21) Appl. No.: 13/661,015

(22) Filed: Oct. 25, 2012

(51) Int. Cl. H01Q 9/28

(52) U.S. Cl. 343/795

(57) ABSTRACT

An omnidirectional dual polarized antenna having a pair of horizontally disposed antenna elements formed by radially disposed cavities between conductive materials on a dielectric substrate. A plurality of vertically disposed antenna elements are engaged in a space between the pair of horizontally disposed antenna elements yielding an omnidirectional antenna capable of transmission and receipt of horizontal and vertical polarized RF signals.

This application claims priority to, U.S. Provisional Patent Application No. 61/551,085 filed on Oct. 25, 2011 and is a Continuation in Part of U.S. patent application Ser. No. 13/660,974 filed on Oct. 25, 2012, which is a Continuation-in-Part of International Application Serial No. PCT/US2012/024381 filed on Aug. 2, 2012, which claims priority to U.S. application Ser. No. 13/369,263 filed on Feb. 8, 2012, which claims priority to U.S. Provisional Patent Application No. 61/440,744 filed on Feb. 8, 2011, and to U.S. Provisional Application 61/551,150 filed on Oct. 25, 2011, all of which are respectively included herein in their entirety by this reference.

### BACKGROUND OF THE INVENTION

1. Field of the Invention

The present invention relates to antennas for transmission and reception of radio frequency communications. More particularly, it relates to an omnidirectional antenna, employing vertically disposed planar antenna elements as well as arrays of horizontally disposed planar shaped antenna elements formed of a single substrate. The antenna so configured is especially well adapted for high definition television communications, as well as a wide number of other frequencies, and which are employable for omnidirectional coverage in horizontal, vertical, and circular polarization.

2. Prior Art

Antennas provide electronic communication for radios, televisions, and cellular telephones and have come to define the information age that we live in. When constructing a communications array such as an HDTV antenna broadcast site, or a wireless communications grid, the builder is faced with the dilemma of obtaining antennas that are customized by providers for the narrow frequency to be broadcast as well as polarization for various individual digital signals. Most such antennas are custom made using antenna elements to match the narrow band of frequencies and polarizations scheme licensed or to be employed at the site, all of which can vary widely depending on the network and venue. The use of horizontal, vertical, or circular polarization schemes may be desired to either increase bandwidth carrying ability from a single site and the potential number of connections. Or such may be the industry standard for broadcasting in a particular polarization orientation.

For users receiving HDTV, radio, wireless internet, and other wideband communications, the direction of incoming transmissions is of particular concern. For instance, in any given community, commercial television stations may have broadcast towers which surround a user's reception site. Thus, to receive different channels of HDTV, broadcast from different directions, the user is faced with a dilemma. Pointing a conventional directional antenna at one broadcast tower, will cause poor reception from others. Using conventional dipole or similar omnidirectional antennas yields poor signal reception. Further, with the advent of neighborhood nodes for the broadcast and reception of wireless transmissions such as for internet communications, wireless cable television and the like, users need antennas for reception and transmission to local towers should they wish to subscribe for internet or media services. Since HDTV and cellular phones, and local wireless internet and local wireless cable television all broadcast on different frequencies, users face the prospect of multiple antennas on their roof or in their attic should they wish to maximize their reception and their internet services.

As such, due to the differing polarization schemes of the various wireless communications and media available to users, antenna construction is greatly affected by the intended polarization of reception and transmission, the direction of incoming and transmitted signals, and the wide variance in bands and frequencies. Low frequencies require longer or larger antennas and higher frequencies require shorter antennas however suffer greatly from line loss. The wide variance in frequencies and direction of broadcast and reception, conventionally require a plurality of individual antennas adapted for polarization, signal direction, frequency, and gain required for operation of an electrical component. This is especially true of HDTV where broadcast signals are at lower power than analog television, and for local RF internet and television connections.

However, because multiple antennas with multiple lead wires are unsightly and can suffer for interference with each other, it is desirable to have a single receiving/transmitting antenna capable of employment in all polarization schemes, in all directions. Such an antenna in addition to being capable of transmission and reception across a wide band of frequencies, should obtain adequate gain on all such frequencies desired and be able to operated in both horizontal and vertical polarizations to increase bandwidth available to users. Further, because local wireless neighborhood internet and television services require two-way communication, such an antenna should also be capable of transmission and reception of RF omni-directionally, 360 degrees in an azimuth plane. This would allow a single antenna to replace the current required array of individual antenna elements users employ pointing in different directions to enable reception and transmission at 360 degrees surrounding the device.

U.S. Pat. No. 4,814,777 Monser is similar to conventional art employed and taught, and teaches a dual-polarization, omni-directional antenna system comprising vertical and horizontal antenna elements having omni-directional radiation patterns. However, Monser teaches the use of multiple dipole antenna elements which in practice may be unsightly and bulky.

Furthermore, although the horizontal and vertical elements may be disposed in closed proximity, there still exists a space requirement for employment due to the high potential of multiple antennas interfering with each other. For instance, for optimum performance, adjacently positioned transmission and reception antennas, must be properly spaced. If the antenna elements are not spaces vertically and horizontally stacked antennas more than wavelength apart, they will adversely load each other. This loading is caused by the elements of one antenna re-radiating some of their received energy, or broadcast energy, into the element of the other antenna. Since optimum spacing is at least wavelength and preferably a full wavelength of the lowest frequency employed, multiple antennas must be spaced apart and are unsightly at best.

As such, there is a continuing and unmet need for a unitary structure broadband high gain antenna, for omni-directional reception and transmission. Further such an antenna should be employable, in combination with vertically disposed wideband antenna elements to provide for RF reception and transmission in the vertical, horizontal, and in some cases circular polarization patterns to allow users the most versatility and usability of the formed antenna for present and upcoming RF provided services.

Such a device should eliminate the requirement for multiple antennas and the spacing and multiple wires employed by the provision of a planar array of antenna elements capable of providing for a wide range of different frequencies to be transmitted and received in a 360 degree pattern. Such a device, by using a plurality of individual antenna elements of substantially identical configuration, formed as a unitary structure in an array of at least three and preferably four of these elements, should allow for omni directional reception and transmission, and/or employ individual lead lines which are switchable in order to increase or decease gain from a particular direction, and/or steer the individual communications beams and/or RF reception therefrom if needed.

### SUMMARY OF THE INVENTION

The device and method herein disclosed and described achieves the above-mentioned goals through the provision of a combination a plurality of antenna elements configured for 360 degree coverage of broadcast digital signals and transmission, along with a plurality of operatively placed vertical wideband notch antenna elements orthogonal to the arrayed elements for omnidirectional coverage in both vertical and horizontal polarizations. Using a unitary planar formation of an array of antenna elements, each of which being adapted for reception and broadcast in a wideband of frequencies between a highest and lowest frequency, and each pointing a different direction the device provides for omnidirectional, or switched direction of the transmission and reception of RF signals.

Currently, the array of elements formed in a unitary structure of conductive material on a dielectric substrate is formed in single plane. The unitary structure yields three or more formed wideband notch antenna elements, each of which is uniquely shaped to provide transmission and reception capability in a wideband of frequencies. Four formed elements are a particularly preferred mode of the device herein.

Additionally, inductance and resulting impedance can be optimized to thereby yield better coverage and gain throughout the entire wideband of the elements through the formation of opposing planar conductive plate, and apertures formed in the conductive material forming the unitary structured multi element antenna. Rectangular apertures in a registered engagement with opposing rectangular plates, formed of substantially the same area, have been found to significantly enhance the impedance characteristics of the formed antenna element and the relative sizes of these apertures and plates may be adjusted as a percentage of increase or decrease in area of the formed unitary multi-element structure for differing bandwiths.

Of course more individual radiator and reception elements may be formed in the single planar body if desired for overlapping coverage and less if coverage in less than 360 degrees is desired. The notched planar antenna elements formed singularly on a planar bodies of the top and bottom of the formed array, are operatively engaged to single planar notched elements orthogonal to the planar components, for transmission and reception in the orthogonally opposing polarized frequency, namely, vertical and horizontal. Similarly, with a plurality of vertical radiator elements operatively engaged and orthogonally opposed to the planar body employing an array of such radiator elements, allows for 360 degree coverage in the polarization orthogonal to the planar array. Individual lead lines from each orthogonally placed element, and each of the horizontal antenna elements of the unitary structure, and be joined at a junction and electrically communicated through a single lead line, or they may be switched and separated to allow for individual transmissions and receptions from each horizontal and vertically disposed wideband antenna element.

Employing antenna elements formed on the top and bottom of planar dielectric material, in an array, with vertical antenna elements formed on a planar dielectric bodies, and orthogonally opposed, with each substantially identical to the other and each capable of RF transmission and reception across a wide array of frequencies, omnidirectional coverage in both horizontal and vertical polarizations is achieved.

The result being the formation of an antenna component having an array antenna elements engaged with a plurality of single antenna elements which provides an elegantly simple solution to the problem of omnidirectional coverage in both horizontal and vertical polarizations within a unitary structure. In addition to being omnidirectional using multiple and orthogonally opposed planar notched antenna elements, each such element is highly customizable for frequency, gain, steering, and other factors, for the particular purpose in mind, by a variance of the widest and narrowest points of the formed elements. Impedence matching of the formed antenna elements can be accomplished with the positioning of the aforementioned plates and opposing apertures in conductive material. 61/551,085

The radiator element providing reception and if desired, transmission of broadcast RF signals, of the disclosed invention is based upon a planar antenna element formed by printed-circuit technology of a notched antenna between two opposing lobes. The antenna element is of two-dimensional construction forming in a manner similar to a horn or notch antenna type, however it features four individual antenna elements facing different directions formed as a unitary structure in the conductive material formed on the planar dielectric.

The planar conductive portion of each of the plurality of formed antenna elements, is formed of a conductor, such as copper, which is positioned on a dielectric substrate of such materials as MYLAR, fiberglass, REXLITE, polystyrene, polyamide, TEFLON, fiberglass or any other such material suitable for the purpose intended. The dielectric substrate and formed conductor may be flexible whereby the antenna can be rolled up for storage and unrolled into a planar form for use. Or, in a particularly preferred mode of the device herein, it is formed on a substantially rigid substrate material in the planar configuration.

The plurality of individual antenna elements themselves, is formed in a radial pattern on the substrate of conductive material, such as any suitable conductive material, for instance, aluminum, copper, silver, gold, platinum or any other electrically conductive material suitable for the purpose intended. The conductive planar material portion, forming the unitary structure defining the plurality of omnidirectional elements, is positioned on the dielectric substrate by any conventionally employed mode known in the art.

In a particularly preferred embodiment, each single planar antenna element of the plurality in the unitary structure, is formed in the conductive planar material on a first side of the substrate currently between 2 to 250 mils thick, through the formation of a gap in the conductive material, in between opposing lobes, in the form of a horn having a curved or serpentine extension which turns to parallel a line extending between the widest point of the cavity which also defines a mouth of the cavity. The formed cavity between the opposing lobes, has the general appearance of a cross-section featuring two lobes or half-sections in a substantially mirrored configuration extending from a center, to widest points on an edge, positioned a distance from each other at their respective edges of opposing lobes.

A cavity beginning with a large uncoated or unplated surface area of the substrate between the respective tips of the two lobes has a mouth of the cavity. The cavity is substantially centered between the two distal points on each leaf or lobe of the clover-shaped unitary structure forming the four radiator or antenna elements. The formed cavity between opposing lobes extends substantially perpendicular to a horizontal line running between the two points defining the mouth and widest point, and then communicates with a tail portion which curves into the body portion of one of the lobes and extends away from the other lobe, in a direction parallel with the line defining the mouth.

Along the cavity pathway, from the points of the element halves or lobes at the widest point, the cavity narrows continually in its cross sectional area. The cavity is at a widest point between the two points on opposing lobes, and narrows to a narrowest point. The cavity from this narrow point then extends to a tail curvilinear portion which curves to extend to a distal end within the one opposing lobe, where it makes a right angled extension from the centerline of the declining cavity. The area of uncovered substrate occupied by this tail section has a direct effect upon the antenna impedance and as such is adjusted for area for impedance matching purposes. Exceptional adjustment is achieved using opposing apertures in conducive material of the lobes, and plates formed adjacent to the distal ends of feed lines on the opposite side of the dielectric substrate.

The widest point of the cavity between the two points of the radiator halves or lobes, determines the low point for the frequency range of the element. The narrowest point of the cavity between the two halves determines the highest frequency to which the element is adapted for use. A current favored configuration of HDTV has a widest point of the radiator element of 6.37 inches and the narrowest point yielding the highest frequency reception and transmission at 0.22 inches. The conductive material 13 is currently copper 1.5 mil thick on a dielectric substrate 25 of about 27 mils thick to space the plate formed on the opposite surface from the conductive material optimally from the aperture. This yields an omni directional horizontally disposed plurality of antenna elements which operate well between 470 MHz to 950 MHz for HDTV. Other formed spacings of the widest and narrowest points of the plurality of antenna elements in the unitary structure operate well in a range of frequencies including 470-860 MHZ, 680-2000 MHZ, 2-6 ghz, 6-18 ghz, 18-40 ghz, and 40-100 ghz. Of course those skilled in the art will realize that by adjusting the widest and narrowest distances of the formed cavity, the element may be adapted to other frequency ranges and any antenna element which employs two substantially identical leaf or lobe portions to form a cavity therebetween with maximum and minimum widths is anticipated within the scope of the claimed device herein. Further, impedance can be matched for the formed structure using the opposing plate and aperture configuration shown.

On the opposite surface of the substrate from the formed radiator element, a plurality of feedlines extend from the area of the cavity intermediate the first and second halves or lobes on each side of the cavity forming the radiator element and passes through the substrate to a tap position to electrically connect with the radiator element which has the cavity extending therein to the distal end perpendicular extension.

The location of the feedline connection, the size and shape of the two halves of the radiator element, and the cross sectional area of the cavity may be of the antenna designers choice for best results for a given use and frequency. Currently, a curve and then parallel path of the curvilinear cavity to the line defining the widest point of the cavity is favored due to exceptional gain, and forming a smaller footprint of the formed element. However, because the disclosed unitary structure with multiple radiator elements performs so well across such a wide bandwidth the current mode of the radiator element as depicted herein, with the connection point shown, is especially preferred. Of course those skilled in the art will realize that shape of the half-portions and size and shape of the cavity may be adjusted to increase gain in certain frequencies or for other reasons known to the skilled, and any and all such changes or alterations of the depicted radiator element as would occur to those skilled in the art upon reading this disclosure are anticipated within the scope of this invention.

The array of omnidirectional radially positioned antenna elements, formed in a unitary structure, as depicted and described herein performs admirably across many frequencies and spectrums employed by individuals, government and industry and is as such a breakthrough in antenna element design. Currently, performance is shown by testing to excel in a range of frequencies including but not limited to 470-860 MHz, 680-2000 MHz, 2-6 GHz, 6-18 GHz, 18-40 GHz, 40-100 GHz, with bandwidth capabilities being adaptable through changing of the widest and narrowest points and through some novel lobe shapes to optimize frequencies and impedance tuning. Such a wide range in the RF spectrum from a single radiator element is unheard of prior to this disclosure. Using the disclosed array of four or more antenna elements herein with each having two shaped lobes or halves, yields highly customizable antennas.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide an antenna that may be constructed comprising one or a plurality of planar bodies with an array of four or more individual elements formed on the body in a plurality of directions to yield omnidirectional transmission and reception in a given frequency polarization and a plurality of planar bodies with a single individual element formed on the body arranged orthogonally and operatively for omnidirectional transmission and reception in an orthogonally opposed frequency polarization.

### BRIEF DESCRIPTION OF DRAWING FIGURES

FIG. 1 is an isometric overhead view of the device detailing the various horizontally disposed, and vertically disposed antenna elements forming omni directional multiple polarization antenna herein.

FIG. 2 is an opposite isometric view of the device detailing the underside of the device and various components.

FIG. 3 is a top plan view of one of the arrayed components of the device showing the radially positioned omnidirectional array of radiator or antenna elements formed in a unitary structure which are positioned on the top and bottom of the device.

FIG. 4 shows a view of the opposite or second surface of the arrayed components forming the top and bottom of the device showing the plurality of feedlines corresponding to the radially disposed array of radiator elements.

FIG. 5 shows again the top view of the radially disposed plurality of antenna or radiator elements further depicting the location of the feedlines shown by dashed lines, and the registered opposing positioning of formed apertures and conductive plates.

FIG. 6 depicts a front view of a wide band individual radiator elements which are positioned orthogonally opposed the top and bottom unitary radially positioned omnidirectional antenna elements.

FIG. 7 shows a rear view of individual radiator element of FIG. 6.

FIG. 8 shows a top plan view of the orthogonally disposed antenna or radiator elements further depicting the location of the feedline on the opposing side, shown by dashed lines.

### DETAILED DESCRIPTION OF THE PREFERRED EMBODIMENTS OF THE INVENTION

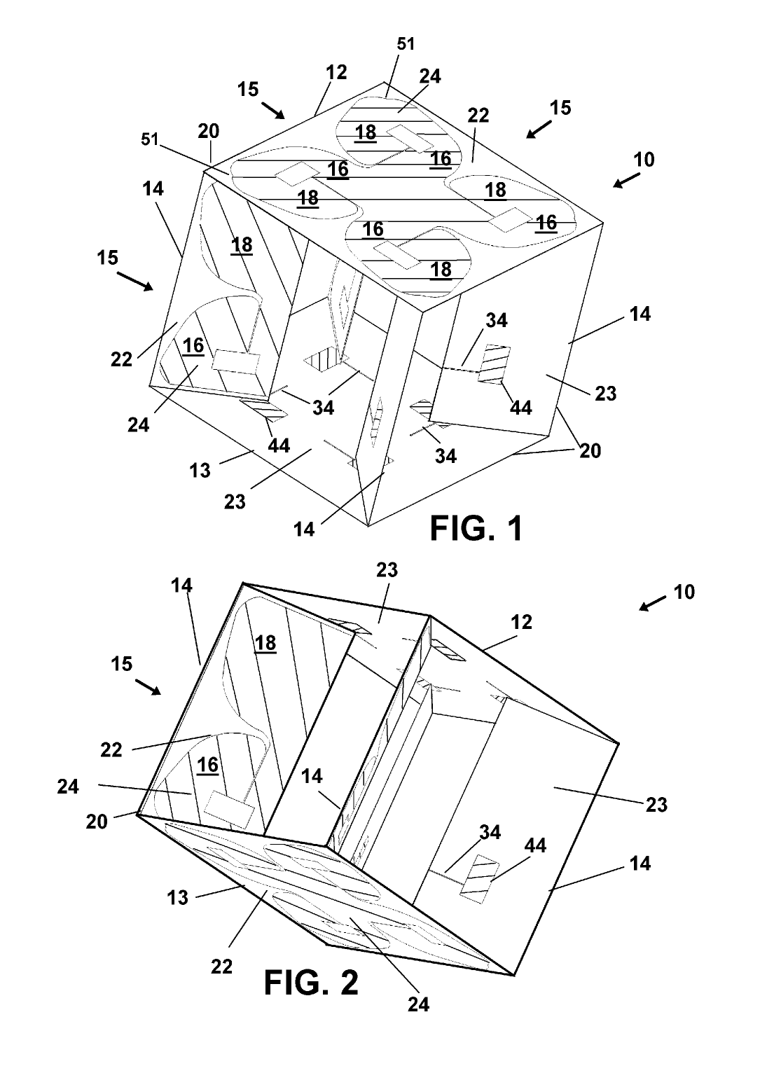

Now referring to drawings in FIGS. 1-8, wherein similar components are identified by like reference numerals, there is seen in FIG. 1 a view of the device 10 showing the first component 12 and second component 13 employing arrays of radiator elements 15, and are generally identical. Also shown are a plurality of antenna elements shown as vertical components 14 employing individual radiator elements 15 and are operatively engaged and orthogonally opposing the first 12 and second 13 components. In use, the arrayed components 12, 13 are generally orientated in the horizontal to provide omnidirectional coverage for the horizontal polarized azimuth plane. In general the vertical components 14 are arranged at substantial equidistant locations about a imaginary center of the first and second components to provide omnidirectional coverage in the vertical polarized plane. Further detailed descriptions will be set forth shortly in the accompanying figures.

It must be noted that the device 10 is further capable of left and right circular polarized reception and transmission given that circular polarization is merely a combination of the two linear components. The polarization and frequency diversity achieved by the device 10 provides unmatched characteristics of prior art antennae.

Generally, the radiator elements 15 formed in a radial pattern of four on the top and bottom surfaces, are formed of a unitary structure when viewed from overhead which is shaped much like a four leaf clover. Each such element 15, and is depicted having two halves which are formed by a first lobe 16 and second lobe 18 looking much like leaves and being substantially identical or mirror images of each other. The radiator elements 15 are formed on the first surface 22 of a substantially planar non-conductive substrates 20. On the second surface 23, a feedline 34 extends and passes through the substrate to electrically connect to the first lobe 16. Again, further details will be set forth shortly. For the arrayed components 12, 13 there is seen on the opposite surface of the substrate an array of feedlines 34 corresponding to the array of individual radiator elements 15. FIG. 2 further shows a view of the device 10 depicting the radiator elements 15 of the second arrayed component 13.

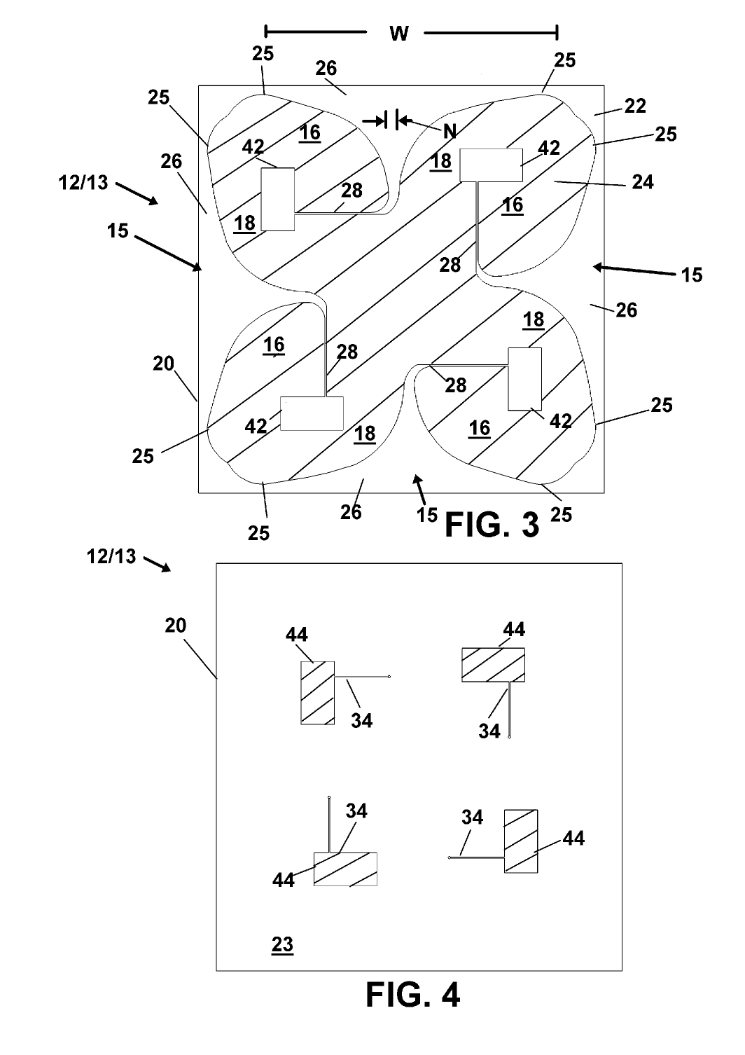

FIG. 3 depicts the first component 12 employing an array of radiator elements 15, each individual radiator element 15 is depicted having two halves which are formed by a first lobe 16 and second lobe 18 being substantially identical or mirror images of each other. It must be noted that the second component 13 is substantially similar to the first competent 12 insomuch as the following descriptions of FIGS. 3 and 4 hold true for both components. The first 12 and second 13 components are preferably comprised of four or more antenna elements with four depicted merely for demonstrative purposes and should not be considered limiting. However, the plurality of elements may be three or two if less coverage around a point is desired.

Each array of radiator elements 15 of the invention is formed of planar conductive material on a substrate 20 which as noted is non conductive and may be constructed of either a rigid or flexible material such as, MYLAR, fiberglass, REXLITE, polystyrene, polyamide, TEFLON fiberglass, or any other such material which would be suitable for the purpose intended.

A first surface 22 shown is coated with a conductive material by microstripline or the like or other metal and substrate construction well known in this art. Any means for affixing the planar conductive material cut to the appropriate shape to form the lobes, to the substrate, is acceptable to practice this invention. The conductive material 24 as for example, includes but is not limited to aluminum, copper, silver, gold, platinum or any other electrically conductive material which is suitable for the purpose intended. As shown in FIG. 3 the surface conductive material 24 on first surface 22 is etched away, removed by suitable means or left uncoated in the coating process to form the first and second lobes and having a mouth 26 leading to a curvilineal cavity 28.

The cavity 28 extending from the mouth 26 has a widest point “W” and extends between the curved side edges of the two lobes 16 and 18 to a narrowest point “N” which is substantially equidistant between the two distal tips 25 and which is positioned along an imaginary line substantially perpendicular to the line depicting the widest point “W” running between the two distal tips 25 on the two lobes 16 and 18.

The widest distance “W” of the mouth 26 portion of the cavity 28 running between the distal end points 25 of the radiator halves or lobes 16 and 18 determines the low point for the frequency range of the radiator elements 15. The narrowest distance “N” of the mouth 26 portion of the cavity 28 between the two lobes 16 and 18 determines the highest frequency to which the radiator element 15 is adapted for use. Of course, those skilled in the art will realize that by adjusting the widest and narrowest distances of the formed cavity, the element may be adapted to other frequency ranges and any antenna element which employs two substantially identical leaf portions to form a cavity therebetween with maximum and minimum widths is anticipated within the scope of the claimed device herein.

The cavity 28 formed by a void in the conductive material forming the lobes, proximate to the narrowest distance “N”, curves into the body portion of one lobe, such as the first lobe 16, and extends away from the other lobe 18. The cavity 28 extends to a distal end within the first lobe 16 where it makes a short right angled extension away from the centerline of the curving cavity 28 and toward the centerline of the mouth 26. This short angled extension and positioning of the curvilinear portion of the cavity 28 parallel to line “W” running between the two widest points 25, has shown improvement in gain for some of the frequencies. Further adjustment of the area of non conductive space in the cavity 28 area, provides one means for impedance matching for radiator element 15.

Additionally, especially preferred, in all sizes and modes of the device 10, is the inclusion of a recess 51 at the distal ends of each lobe component formed by lobes 16 and 18. The recess 51 has proven to be a means to prevent coupling of the horizontally disposed omnidirectional elements with the vertically disposed wideband antenna vertical components 14 therebetween.

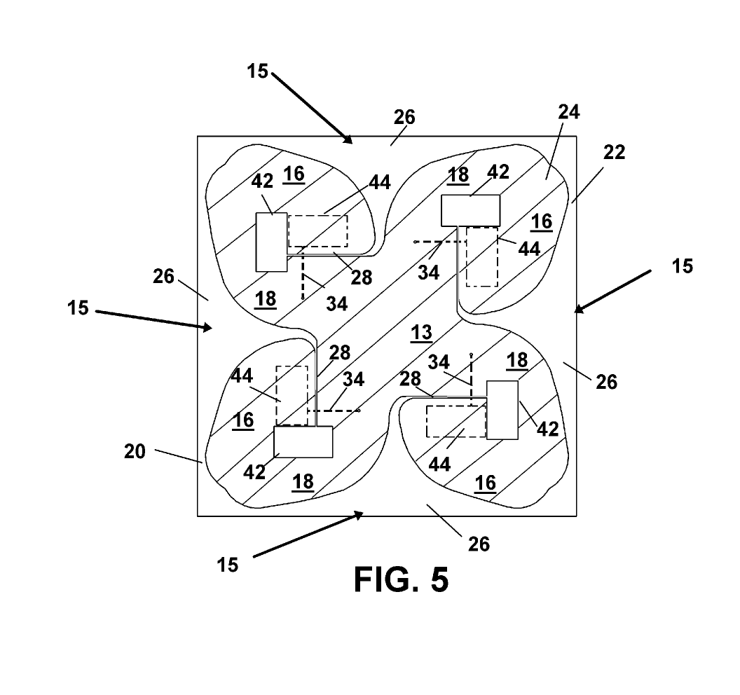

Additionally preferred in all modes of the device, the unitary structure forming the radially deployed plurality of radiator elements 15 forming the top and bottom surface, and the vertically disposed elements, includes a means for optimizing impedance of the formed omnidirectional antenna. This is provided by positioning of an aperture 42 of removed material in the conductive material forming the lobes, and plate 44 formed of conductive material such as copper on the opposing surface the alignment and registration of which is best seen in FIG. 5.

As depicted in FIG. 5, a rectangular aperture 42 is formed in the conductive material, usually copper, forming the lobes 18 and 16 on the upper surface such as seen in FIG. 1. On the rear or second surface 23, a plate 34 formed of conductive material such as copper, is formed as a rectangle. It has been found that by forming the plate 44 in substantially the same shape as the aperture 42, and forming both to have substantially equal areas, that the formed radiator element 15 in both horizontal and vertical dispositions, performs much better in the lower frequency range than without the substantially equal area plate 44 and aperture 42. Currently, a rectangle having long sides between 1.25 inches and 1.75 inches, and having short sides between 0.5 inches and 1 inch provide optimum results. As depicted in FIG. 5, the long sides are 1.45 inches and the short sides 1.77 inches.

Additionally, a positioning of the short sides of the plates 44 on opposite sides of the dielectric sheet, but in a registered positioning to abut one corner and long end of the apertures 42 provides the best optimization of impedance for the formed antenna elements provided by the vertically and horizontally disposed radiator elements 15.

In all modes of the first and second components 12, 13 shown herein, on the opposite surface 23 of the substrate 20 shown in FIG. 4, an array of feedlines 34 extend from the area of the cavity 28 intermediate to the two lobes 16 and 18 forming the two halves of the radiator element 15 and passes through the substrate 20 to electrically connect to and edge or at the first lobe 16 adjacent to the edge of the curved portion of the cavity 28 past the narrowest distance “N.”

The location of the feedlines 34 connection, the size and shape of the two lobes 16 and 18 of the radiator element 15 and the cross sectional area of the widest distance “W” and narrowest distance “N” of the cavity 28 may be of the antenna designers choice for best results for a given use and frequency. However, because the antenna elements 15 perform so well and across such a wide bandwidth, the current mode of the radiator element 15, as depicted herein with the connection point shown, is especially preferred.

To better understand the location and orientation of the feedlines 34 relative to the cavity 28 another top plan view of the first surface 22 is seen in FIG. 5 with the feedlines 34 engaged on the second surface 23 depicted by a dashed line. The feedlines 34 may be individually run to different transmitters and receivers for directional use, or may be connected with a 1:4 corporate power divider/combiner which is currently especially preferred in the optimal mode of the device as a means for combining receive and transmit signals of the arrayed radiator elements 15. The divider/combiner may be a printed circuit microstrip line or coupling can be achieved via RF cables and connectors. The individual 1:4 power divider/combiner of the first 12 and second 13 component are then typically connected through a 1:2 divider/combiner to combine the signals further to a common input/output port.

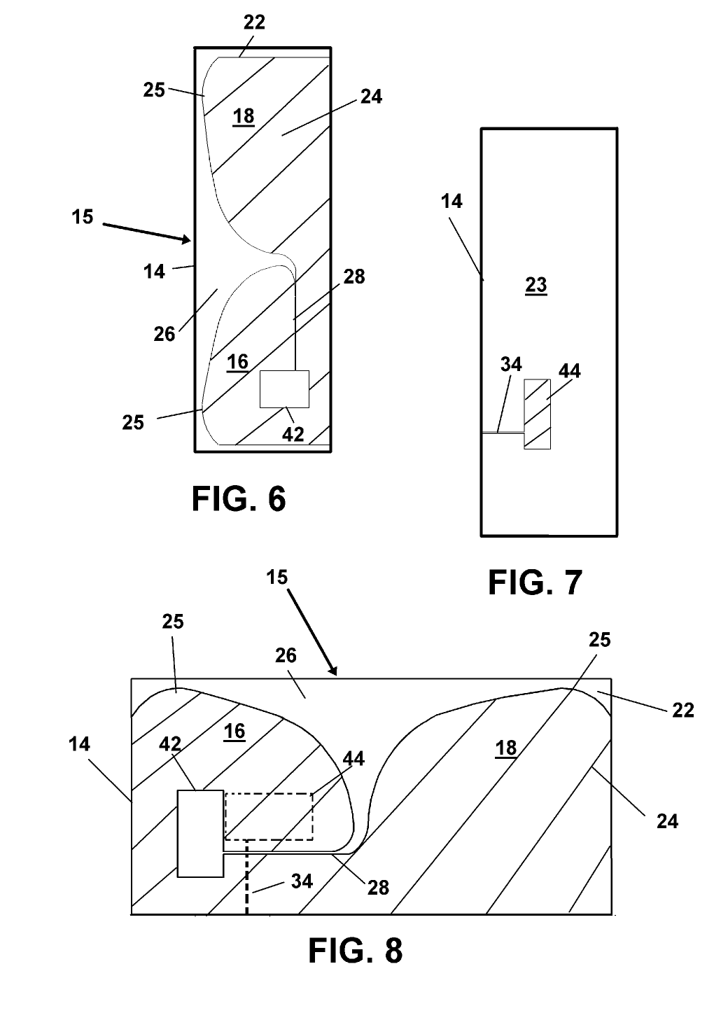

FIG. 6 shows a detailed front view of the vertical component 14 employing an individual radiator element 15. Similar to the arrayed components 12, 13, the radiator element 15 of the vertically disposed vertical components 14 is depicted having two halves which are formed by a first lobe 16 and second lobe 18 looking much like leaves and being substantially identical or mirror images of each other. The radiator elements 15 are formed on the first surface 22 of a substantially planar non-conductive substrates 20. On the second surface 23, a feedline 34 extends and passes through the substrate to electrically connect to the first lobe 16.

Again, the widest distance “W” of the mouth 26 portion of the cavity 28 running between the distal end points 25 of the radiator halves or lobes 16 and 18 determines the low point for the frequency range of the radiator elements 15. The narrowest distance “N” of the mouth 26 portion of the cavity 28 between the two lobes 16 and 18 determines the highest frequency to which the radiator element 15 is adapted for use.

However, it is particularly preferred that the vertical components 14 further employ mirrored “L” shaped extensions 29 extend from those tips 25 to a connection at the lower points of respective lobes 16 and 18. The extensions 29 have been found to significantly enhance performance of the antenna radiator element 15 at lower frequency ranges of the noted frequencies above.

On the opposite surface 23 of the substrate 20 shown in FIG. 7, a feedline 34 extend from the area of the cavity 28 intermediate to the two lobes 16 and 18 forming the two halves of the radiator element 15 and passes through the substrate 20 to electrically connect to the first lobe 16 adjacent to the edge of the curved portion of the cavity 28 past the narrowest distance “N.”

The location of the feedlines 34 connection, the size and shape of the two lobes 16 and 18 of the radiator element 15 and the cross sectional area of the widest distance “W” and narrowest distance “N” of the cavity 28 may be of the antenna designers choice for best results for a given use and frequency. Again to better understand the location and orientation of the feedlines 34 relative to the cavity 28 another top plan view of the first surface 22 is seen in FIG. 8 with the feedlines 34 engaged on the second surface 23 depicted by a dashed line.

The feedlines 34 of the plurality of vertical components 14 are preferably coupled with RF cables to a 1:4 power divider/combiner to a common input/output port.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An omnidirectional dual polarized antenna, comprising:
first and second horizontally disposed antenna elements having a dielectric substrate having a first substrate surface and a second substrate surface opposite said first surface;
a portion of said first substrate surface covered with a conductive material, said conductive material forming a plurality of lobes on opposing sides of respective uncovered portions of said first substrate surface and defining a plurality of radially disposed cavities therebetween;
each said cavity having a mouth, said mouth defined by a line extending between two points located upon said conductive material upon opposing said lobes, said mouth defining a widest point of each said cavity;
each respective said lobes being of substantially equal area and shape;
all of said lobes formed in a unitary structure of said conductive material;
each said cavity reducing in cross-section as it extends from said first edge, to a narrowest point in-between said adjoining lobes;
a curvilinear portion of each said cavity, extending away from said narrowest point, in a curved direction into one of said lobes; and
a feedline electrically communicating at a first end at a point in a respective said curvilinear portion, each said feedline configurable at a second end for electrical communication of horizontally disposed RF signals to an RF receiver or transceiver;
a plurality of vertically disposed antenna elements engaged in a space between said first and second horizontally disposed antenna elements, said vertically disposed antenna elements formed upon a first surface of a dielectric substrate, each having:
a portion of said first surface covered with conducting material, said conducting material forming a plurality of lobes on opposing sides of a gap therebetween;
each said gap having a gap mouth, said gap mouth extending between two points located upon said conducting material upon opposing said lobes, said gap mouth defining a widest point of each said gap;
each said gap reducing in cross-section as it extends from said gap mouth, to a closest point in-between said adjoining lobes;
a curvilinear portion of each said gap, extending away from said closest point, in a curved direction, into one of said lobes; and
a feedline electrically communicating at a first end at a point at or adjacent to a respective said curvilinear portion of said gap; and
each said feedline configurable at a second end for electrical communication to an RF receiver or transceiver for communicating vertically polarized RF signals.

2. The radiator element of claim 1, further comprising:
said plurality of cavities being four; and
said plurality of vertically disposed antenna elements being four, each of said four being perpendicular to adjacent said vertically disposed antenna elements.

3. The radiator element of claim 2, further comprising:
each of said four cavities being positioned at ninety degree angles relative to respective adjacent of said other of said four cavities.

4. The radiator element of claim 1, further comprising:
said first and second horizontally disposed antenna elements having the appearance of a four leaf clover, when viewed from overhead.

5. The radiator element of claim 2, further comprising:
said first and second horizontally disposed antenna elements having the appearance of a four leaf clover, when viewed from overhead.

6. The radiator element of claim 3, further comprising:
said first and second horizontally disposed antenna elements having the appearance of a four leaf clover, when viewed from overhead.

7. The radiator element of claim 1, further comprising:
each of said first and second horizontally disposed antenna elements and said vertically disposed antenna elements having an impedance matching structure having:
rectangular planar plates formed of an electrically conductive material positioned upon respective said second substrate surfaces and respective second surfaces;
a rectangular aperture formed in said conductive material on respective said first substrate surfaces, and respective said first surfaces, in a registered position opposite each respective said planar plate; and
said planar plates and said rectangular apertures being substantially equal in size and dimension.

8. The radiator element of claim 2, further comprising:
each of said first and second horizontally disposed antenna elements and said vertically disposed antenna elements having an impedance matching structure having:
rectangular planar plates formed of an electrically conductive material positioned upon respective said second substrate surfaces and respective second surfaces;
a rectangular aperture formed in said conductive material on respective said first substrate surfaces, and respective said first surfaces, in a registered position opposite each respective said planar plate; and
said planar plates and said rectangular apertures being substantially equal in size and dimension.

9. The radiator element of claim 3, further comprising:
each of said first and second horizontally disposed antenna elements and said vertically disposed antenna elements having an impedance matching structure having:
rectangular planar plates formed of an electrically conductive material positioned upon respective said second substrate surfaces and respective second surfaces;
a rectangular aperture formed in said conductive material on respective said first substrate surfaces, and respective said first surfaces, in a registered position opposite each respective said planar plate; and
said planar plates and said rectangular apertures being substantially equal in size and dimension.
